(19) United States
(12) Patent Application Publication
(10) Pub. No.: US 2006/0043916 A1
(43) Pub. Date: Mar. 2, 2006

(54) Motor system having multiple motor torque constants

(75) Inventors: Mark Henslee, Dothan, AL (US); Richard Haynes, Gulfport, FL (US); John Gamble, Dothan, AL (US)

Correspondence Address: BRADLEY ARANT ROSE & WHITE, LLP;INTELLECTUAL PROPERTY DEPARTMENT-NWJ, 1819 FIFTH AVENUE NORTH, BIRMINGHAM, AL, 35203-2104, US

(73) Assignee: The Consortium, LLC

(21) Appl. No.: 10/932,670

(22) Filed: Sep. 1, 2004

(51) Int. Cl. H02P 7/00

(52) U.S. Cl. 318/432

(57) ABSTRACT

A variable speed electric motor to drive a variable load over a substantially continuous range of speed. The motor has a plurality of winding combinations that may be switched into and out of the motor circuit. A torque controller selects the winding combination in response to motor speed to deliver torque efficiently to the load throughout the speed range.

### BACKGROUND

A significant amount of research and development has been performed over the years to develop a practical electric powered vehicle. However, the traveling range of electric vehicles has been limited to a maximum of 120 miles. Two technical issues that must be solved before electric vehicles will be practical are the development of a power source with a high power density that can be recharged very quickly, and a motor that can efficiently produce torque. Many different types of motors have been used in electric vehicle applications; some motors were claimed to have extremely high electrical efficiencies but no real improvements have been made in vehicle performance or vehicle range.

Typically, the high efficiency motors operate at very high speeds, sometimes at motor speeds in excess of 15,000 rpm (1,571 rad/s) for a maximum vehicle speed of 75 to 80 mph, but require a gear reducer to multiply the torque enough to be useful. A vehicle with a maximum speed of 75 to 80 mph and a range of 100 to 120 miles is not very practical.

There is a considerable body of knowledge, reflected in the prior art, pertaining to the design of alternating current induction motors to operate at multiple fixed speed ranges, such as low, medium, and high speed, against a fixed load, such as a fan. These designs, which usually include a capacitor starting circuit, create the multiple speed ranges primarily by switching the motor field windings, successively, into a series circuit to reduce the current in the motor windings thus reducing the torque applied by the motor to the fixed load. Reducing the torque applied by a motor to the load causes the motor to slow until equilibrium between the motor torque produced and the torque required to move, or rotate, the load is achieved. The method of combining motor windings to reduce, or divide, applied current increases the magnitude of a characteristic known as magnetic slip. In such designs, the motor speed changes as a consequence of switching windings; that is, switching windings is itself used as motor speed control. There is no separate speed controller, such as seen in true variable speed motor designs, and no effort is made to deliver torque efficiently or optimally to the load.

True variable speed motors are controlled by various means. Motor speed is commonly controlled by variable resistance, sine drives such as variable amplitude or variable frequency, or by pulse width modulation. The choice and application of motor speed control is, generally, a matter of application requirements and cost. Regardless of the means of motor speed control, conventional variable speed motor designs have one, and only one, motor torque constant expressing the relationship between current supplied to the motor versus the torque produced by the motor. Most motors are evaluated for efficiency at a specific operating point on the speed versus torque curve for the motor. Conventional motor designs therefore are most efficient at one operating point on the speed versus torque curve, or at best over a narrow range of the speed versus torque curve. They do not efficiently deliver torque outside of this single, narrow speed range. This inefficiency is compounded when the motor is applied to a variable load, which may demand a higher torque at a given time or over certain operating range than it does at other times or over a different operating range.

Thus, a variable speed motor capable of efficiently delivering torque to a varying load over a wide range of speeds is needed. The present invention supplies these needs by providing a system combining a speed controller, a torque controller, and an electric motor with multiple winding combinations that has multiple torque constants, which efficiently delivers torque over a wide range of speeds. The present invention also is applicable to applications requiring varying speeds with a constant torque load.

### SUMMARY

One embodiment of the invention comprises a system for efficiently delivering torque to a variable load operating over a substantially continuous predetermined range of speed, which includes an electric motor, a speed demand input signal, and a torque controller. The electric motor comprises a plurality of winding combinations capable of being switched into or out of the current path through the motor. Each winding combination effects a different predetermined torque constant for the motor. The motor also comprises a speed controller responsive to the speed demand input signal to vary the speed of said motor as required by an operator. The torque controller is responsive to the actual operating speed of the motor to select the winding combination that is predetermined or designed to most efficiently deliver the torque required by the load at the actual motor speed. The motor thus has multiple torque constants and therefore multiple efficient operating points over the speed range. The winding combinations may include a primary winding, a secondary winding, and the primary winding in series or in parallel with the secondary winding. In this way, more than two winding combinations are obtained from two physical windings.

Such a motor is designed by first identifying the speed range and torque requirements of the load and dividing the speed range into intervals that are appropriate for the load. For example, if the load is a vehicle, the speed range of the vehicle may be divided into a low speed interval, a medium speed interval, and a high speed interval. A motor constant is computed based on a selected speed within each of the intervals, such as the maximum speed in each interval. Once the required motor constants are determined, the number of conductors and turns per coil necessary for a winding combination to provide the computed motor constant for each of intervals are computed. Finally, a logic circuit responsive to motor speed to select the appropriate winding combination is designed.

### DESCRIPTION OF DRAWINGS

These and other features, aspects, structures, advantages, and functions are shown or inherent in, and will become better understood with regard to, the following description and accompanied drawings where:

FIG. 1 is a block diagram of one embodiment of the present invention;

FIG. 2A is a front view of the stator, rotor, and stator support of a permanent magnet brushless direct current motor embodiment of the invention, and FIG. 2B is an enlarged view of the primary and secondary windings on the stator of FIG. 2A. FIG. 2C is a front view of the stator of FIG. 2A showing a circuit board motor speed installed onto the stator support.

FIG. 3 is a side sectional view of the stator of FIG. 2A mounted on its support showing the relative position to the rotor.

FIG. 4 is a torque-speed curve of a conventional (prior art) electric motor;

FIG. 5 is a torque-speed curve of an exemplary motor designed in accordance with one embodiment of the present invention;

FIG. 6. is a section view of the motor of FIG. 2A mounted on the hub of the wheel of an electric vehicle;

FIG. 7 is a perspective view of the motor in FIG. 6 mounted into the rear wheel of an electric vehicle, shown as a bicycle;

FIG. 8 is a circuit diagram of an analog embodiment of the torque controller and inverter-combiner circuitry of one embodiment of the present invention.

### DETAILED DESCRIPTION

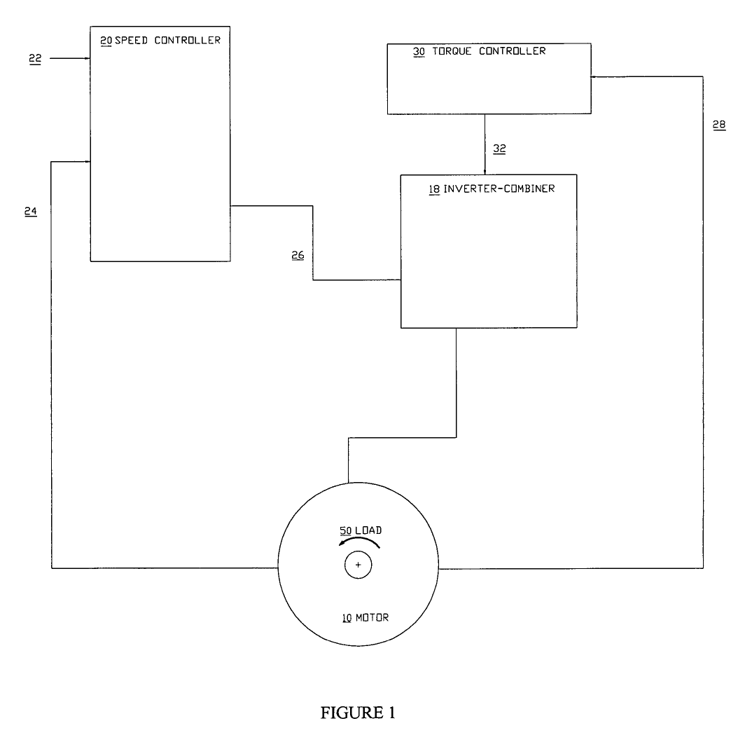

As shown in FIG. 1, one embodiment of the present invention comprises an electric motor 10, a speed controller 20, and a torque controller 30. The electric motor 10 comprises a rotor (not shown in FIG. 1) that rotates at a desired speed and delivers torque to a load 50. As described herein, the speed controller 20 controls the speed of the motor 10, and the torque controller is responsive to motor speed to select a winding combination predetermined to efficiently deliver the torque required by the load 50 at the given motor speed.

The electric motor 10 may be any type of electric motor known in the art, for example, a permanent magnet direct current motor or an alternating current induction motor and the variants of either. While the example of a brushless, electronically commutated permanent magnet DC motor is set forth below, one ordinarily skilled in the art will readily appreciate the applicability of the teachings herein to the other types of motors listed in the preceding sentence.

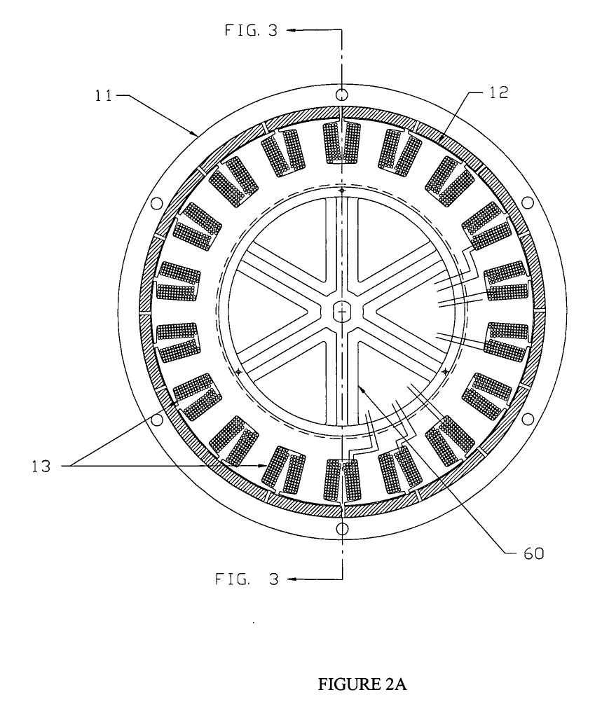

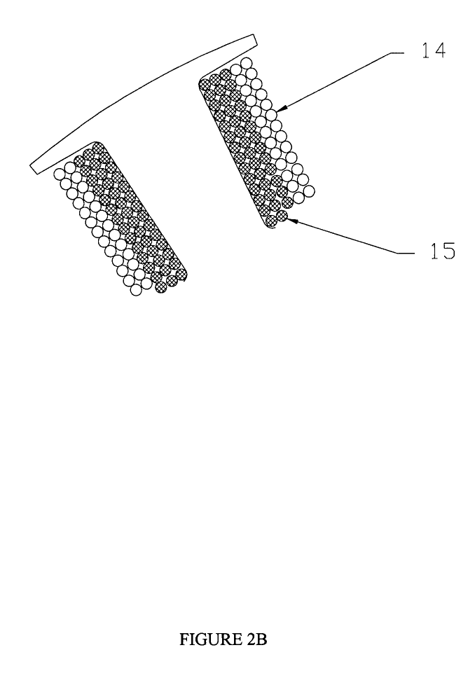

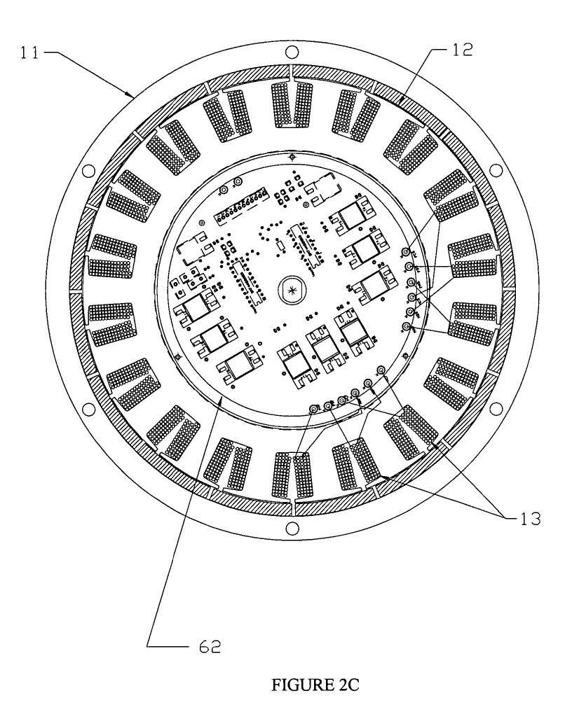

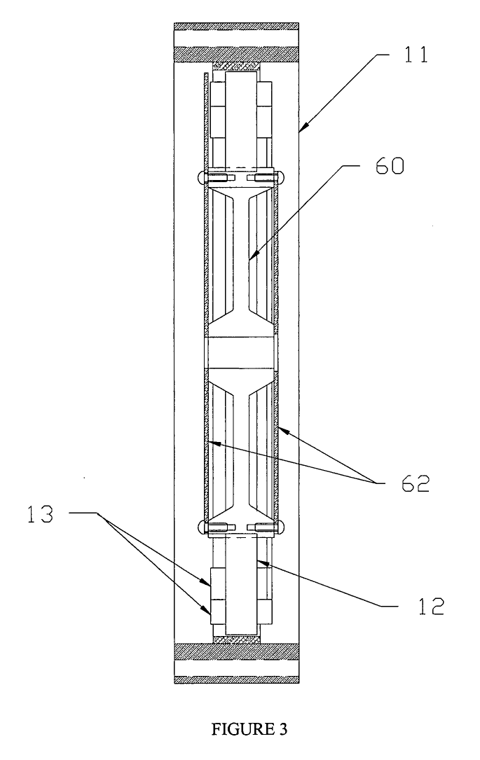

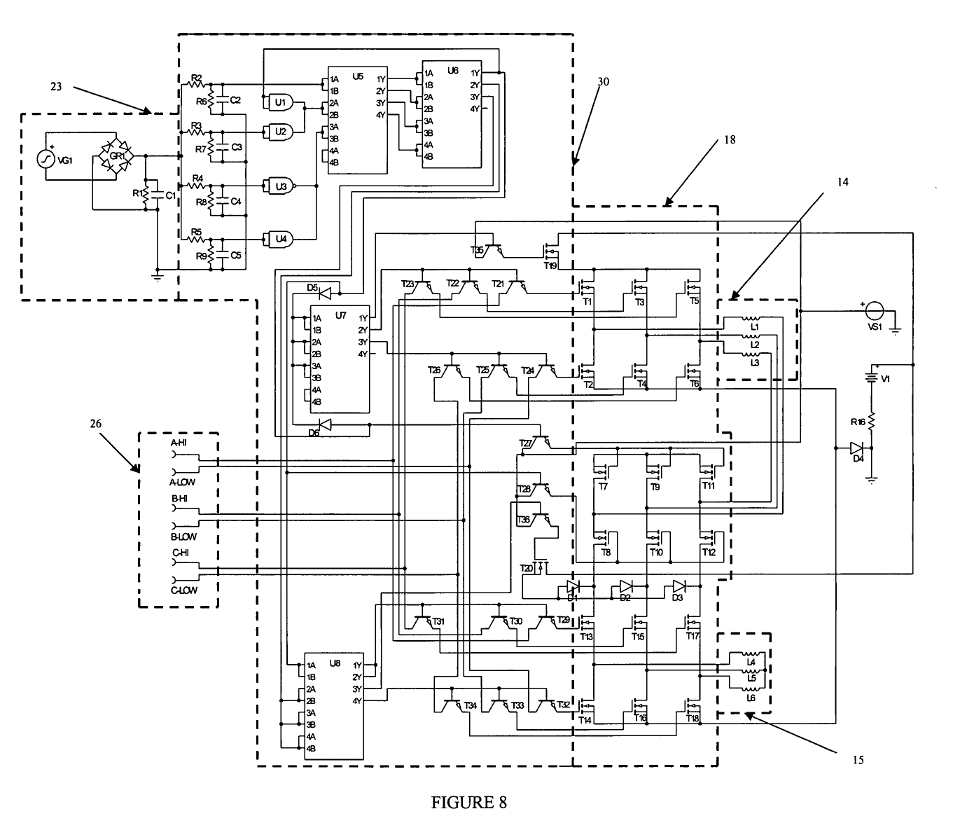

Referring to FIGS. 2A and 3, the motor 10 comprises a rotor 11, a stator 12, and a plurality of windings 13. This description generally discusses a motor configuration with a primary winding 14 and a secondary winding 15, as shown in FIGS. 2A-B. However, a motor embodying the present invention may be designed and constructed with three or more windings as the demands of a particular application require. The motor 10 also includes inverter-combiner circuitry 18, which performs a variety of functions described in more detail in connection with the discussion of FIG. 8 below. In addition, although the motor illustrated in FIGS. 2-3 is an external rotor design, the present invention may also be implemented in an internal (enclosed) rotor design.

One function of inverter-combiner circuitry 18 is to selectively switch the separate windings into or out of the motor circuit individually, or in series or parallel combinations. That is, the motor may operate with only the primary winding activated, with only the secondary winding activated, with the primary and secondary electrically connected in series, or electrically connected in parallel, depending on design. Each of the foregoing options (including the use of an individual winding operating alone) is referred to herein as a winding combination.

As is known in the art, the number of turns of a conductor per coil in a motor winding affects various aspects of the motor's performance, including its speed versus torque characteristic, or in other words, the amount of torque produced by the motor at a given speed and at a given current. In the motor of the present invention, each winding combination has a different number of turns per coil, which causes the motor to have different speed-torque characteristics depending on which winding combination is activated. In other words, the motor of the present invention has multiple torque constants, with the number of torque constants equal to the number of winding combinations in a given design.

The speed-torque characteristic of each winding combination is particularly designed for, and may be optimized for, a predetermined operating range of the application in which the motor will be used. For example, in an electric vehicle application in which the vehicle must accelerate from a start at low speeds (requiring high torque and relatively low motor speed) to a cruising range in which most driving will occur, but with the ability to obtain high speeds on occasion, the motor may comprise a high torque, low speed winding combination (for high torque acceleration from a start), an intermediate torque, intermediate speed winding combination (for cruising speeds), and a lower torque, high speed winding (for maximal vehicle speeds). An exemplary motor design for an electric vehicle application, including speed-torque curves for each winding combination, is set forth below.

A control system comprising a speed controller 20 and a torque controller 30 is provided to control the speed of the motor 10 and utilize the multiple winding combinations available in the motor 10. The speed controller 20 controls motor speed and may be any type of speed controller known in the art and suitable to operate with the type of motor 10, including a variable resistance speed controller, a variable amplitude speed controller, a variable frequency speed controller, and a pulse width modulation speed controller. Whatever type speed controller is utilized typically has three basic signals, shown in FIG. 1: a demand input signal 22, a first motor speed feedback signal 24, and a speed command output signal 26.

The demand input signal 22 may comprise a plurality of individual input signals, such as demanded speed, brake command, regeneration braking, coast, reverse direction, and the like. These signals are derived from operator input, whether that operator is human or some other machine or control system. The first motor speed feedback signal 24 is representative of the actual speed of the motor. In response to the demand input signal 22, the speed controller 20 issues the speed command output signal 26 to the motor 10, causing the motor to speed up, slow down, or maintain the same speed, depending on the comparative relationship between the demand input signal 22 and the actual motor speed as represented by the first motor speed feedback signal 24. The speed controller 20 and portions of the inverter-combiner circuitry 18 responsive to the speed controller operate similarly to a conventional variable speed motor with speed control.

The second aspect of the control system for motor 10 is the torque controller 30. The torque controller 30 has a second motor speed feedback signal 28 as an input (which may be implemented independently of the first motor speed feedback signal, and hence is given a distinct name and reference numeral herein), winding select signal 32 as an output. (Depending on the circuit used to implement the logic of the torque controller, winding select signal 32 may be the composite of more than one physical signal; for example, with reference to FIG. 8, the collective output of a multi-branch logic circuit comprises the winding select signal). As noted, the speed-torque characteristic of each winding combination is designed or optimized to produce torque for a predetermined range (or interval) of motor speeds. Torque controller 30 receives the actual motor speed via second motor speed feedback signal 28, selects the winding combination predetermined to correspond to that motor speed, and issues the winding select signal 32 specifying that winding combination to the inverter-combiner circuit 18, which switches the specified winding combination into the current path of the motor. The torque controller 30 therefore is a straightforward logic circuit, and it may be implemented via analog logic circuitry (exemplified below), integrated circuits, or digital signal processing methods known in the art.

Unlike previous multiple-winding electric motors, the selection or switching of winding combinations is not used as a speed control. Previous switched-winding electric motors in the art use changes in the magnetic slip (and thus torque) resulting from a change in windings to cause the motor to change speed until an equilibrium is reached between the torque produced by the winding combination and a fixed load, thus effecting a fixed change in speed with each switch of the winding. Efficiency and current requirements are not a consideration, and a variable and continuous range of speeds is not possible with such a design.

In contrast, in the present invention, speed control is accomplished via the speed controller, which allows a continuous variable range of speed. The torque controller then selects winding combinations designed or optimized for predetermined portions of this variable speed range to provide the required torque to the load with efficiency. In this way, the electric motor 10 has multiple efficient operating points over a wide continuous range of speeds, which is not possible with either a variable speed single-winding motor or a multiple-winding motor with stepwise fixed speeds. Further, the motor 10 provides the required torque over this wide range with less current than a conventional motor design.

### EXAMPLE

The following discussion sets forth the parameters of a conventional electric motor design followed by the parameters of an exemplary embodiment of the present invention for an exemplary electric vehicle application. While the particular numbers and data used are specific to this example, the design considerations, methods, and techniques taught below are applicable to a broad array of applications and motor systems designs.

A motor for an electric powered bicycle, rated at 400 Watts, provides a comparative basis of performance to a conventional motor and illustrates the practical benefits of an example of one embodiment of the present invention. A permanent magnet brushless direct current motor used and applied as a traction motor for an electric powered bicycle is used in this example.

The conventional motor design typically begins with determining the maximum desired motor operating speed and torque required by an application. The maximum motor operating speed is expressed in radians per second divided by a factor determined by the expected flux linkage of the magnetic field to the conductor coil windings yields the motor no-load speed. In the case of a permanent magnet brushless direct current motor, used for explanatory purposes, the expected flux linkage coefficient of rare earth magnets is ninety percent. The motor constant is determined by dividing the supply voltage by the motor no-load speed yielding volts per radians per second:
kₘ=Vₛ/w_{NL}
where Vₛ: motor supply voltage, w_{NL}: motor no-load speed.

After determining the motor no-load speed and the motor constant, the number of magnetic poles and field poles, often referred to as “poles and slots,” are selected. In the case of a wye connected permanent magnet brushless direct current motor used in this example, the number of conductors, Z, in the motor is determined as:
Z=(3/2)kₘ(a)π(C)p(F)
where kₘ: motor constant, a: number of parallel paths, C: flux linkage coefficient, p: number of pole pairs, F: flux.

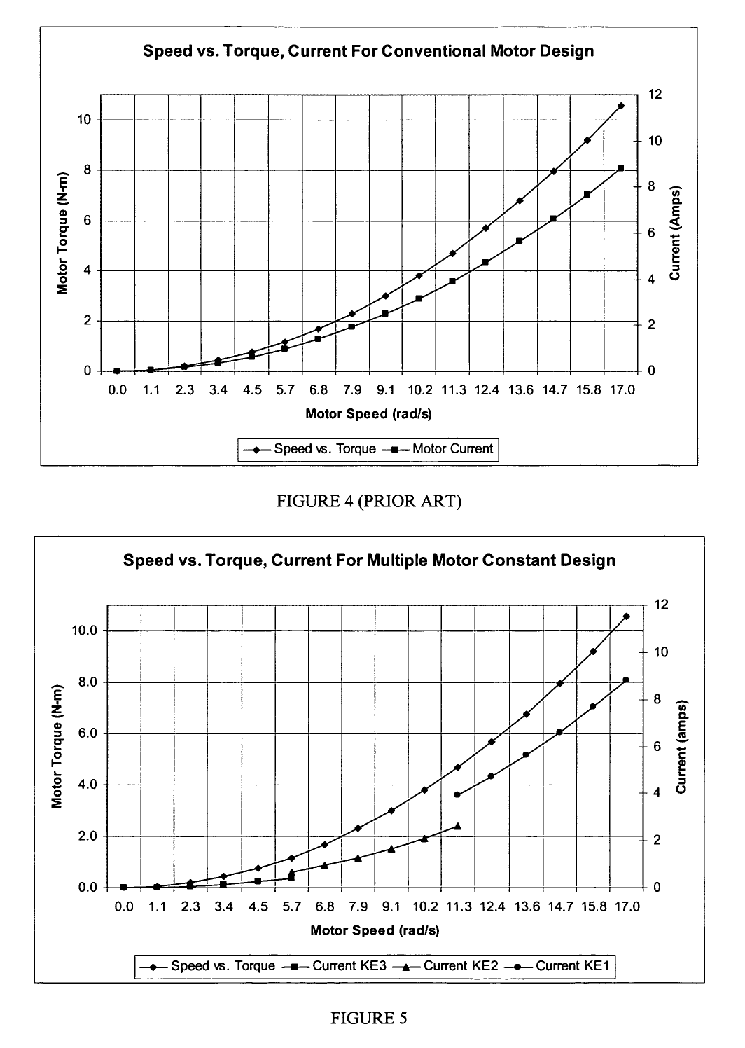

The number of turns per coil, N, is calculated as:
N=Z/[(2)(number of slots)]
The number of turns per coil, N, is therefore directly related to the maximum operating speed and desired operating torque for the specific application which results in a single point or narrow range of optimum efficiency of a conventional motor. The current required by the conventional permanent magnet brushless direct current motor design used as an example is shown in FIG. 4.

Using a desired maximum motor operating speed of 16.97 rad/s, a flux linkage coefficient of 0.85, and a supply voltage of 24 volts DC, a conventional motor, according to equations above, will have the following parameters:
Maximum motor operating speed: 16.97 rad/s
Flux linkage coefficient, C: 0.85
Motor no-load speed, w_{NL}=16.97 rad/s/0.85=19.96 rad/s
Supply voltage, Vₛ: 24 Vdc
Motor constant, kₘ=24 Vdc/19.96 rad/s=1.20 V-s/rad

In metric units, kₘ, is numerically equal to the motor voltage constant, kₑ (V-s/rad) and the motor torque constant, k_{T} (N-m/amp). Thus k_{T} is equal to 1.20 N-m/amp, or for every one (1) amp of current supplied to the motor, the motor produces 1.20 N-m of torque. For the purposes of illustration and comparison, this motor torque constant is designated as k_{T1}.

This conventional motor design will operate at its highest efficiency at a motor speed of 16.97 rad/s (15 mph), the maximal speed of the vehicle. Because aerodynamic drag increases as the square of vehicle speed, the most efficient operating point of a conventional (prior art) motor design coincides with the greatest aerodynamic drag force exerted on the vehicle. As a result, a high motor current is required to generate a torque sufficient to maintain the maximal vehicle speed. At lower speeds, although the aerodynamic force exerted on the vehicle decreases, the motor operates at a lower efficiency, consuming more current than a motor optimized for such lower speeds. Thus, the single point of maximum efficiency of a conventional motor is a barrier to increased vehicle range.

FIG. 4 shows the speed versus torque curve, S/T curve, of the conventional (prior art) permanent magnet brushless direct current motor and the current required for the speed and torque performance of the motor. The range of motor speed, 0 to 17.0 rad/s, corresponds to a constant speed for the bicycle of 0 to 15 miles per hour in this example at each point. The aerodynamic force (F_{cd}) is calculated as: F_{cd}=C_{d}(v²)(A)(r), where F_{cd}: aerodynamic drag force, C_{d}: coefficient of drag, v: vehicle velocity, A: frontal area, r: air density at 1.225 kg/m³. Motor torque (Tₘ) is calculated as: Tₘ=F_{cd} (wheel radius), and required motor current (I) is calculated as: 1=Tₘ/k_{T}, where k_{T} is the motor torque constant in N-m/amp.

FIG. 4 shows the motor speed, torque, and current curves of the conventional motor design with a motor torque constant, k_{T} of 1.20 N-m/amp, for the electric bicycle traveling on a level surface. The torque is required to overcome aerodynamic drag.

To accelerate the bicycle and rider, at a total mass of 126 kg, from zero velocity to fifteen miles per hour, 6.25 m/s, in six seconds requires an initial motor torque of 48.5 N-m. The current required to produce the 48.5 N-m of torque required for the desired rate of acceleration is 40.4 amps.

The capacity of portable power sources, such as batteries, is expressed in terms of Watt-hours or ampere-hours. The higher the current required by the motor to produce the required torque, the shorter the time required to discharge the power source. The characteristic of a low motor current to efficiently generate torque is therefore highly desirable in the example application.

The example of one embodiment of the present invention begins in a manner similar to a conventionally designed motor above:
Maximum motor operating speed: 16.97 rad/s
Flux linkage coefficient, C: 0.85
Motor no-load speed, w_{NL}=16.97 rad/s/0.85=19.96 rad/s
Supply voltage, Vₛ: 24 Vdc
Motor constant, kₘ=24 Vdc/18.86 rad/s=1.20 V-s/rad

For illustration, the motor is designed to have three motor constants with the goal of efficiently generating torque at lower speeds, thus increasing the range of the bicycle. The first step is to calculate the desired motor constant for the maximum operating speed of the motor; this yields the same result as the conventional motor design above. Therefore, k_{T1}=1.20 N-m/amp.

Dividing the desired motor speed ranges into intervals that seem practical for useable speed ranges for the bicycle, which do not have to be of equal magnitude, let:
Low range: 0 to 5 mph (0 to 5.66 rad/s)
Cruising range: 5 to 10 mph (to 11.31 rad/s)
High range: 10 to 15 mph (to 16.97 rad/s)

Following the method of calculation described previously, the motor constants are:
Low range: k_{T3}=3.00 N-m/amp
Cruising range: k_{T2}=1.80 N-m/amp
High range k_{T1}=1.20 N-m/amp

Calculating the number of conductors, Z, using the equation below for each of the motor constants, k_{T1}=1.20 N-m/amp, k_{T2}=1.80 N-m/amp, and k_{T3}=3.00 N-m/amp,
Z=(3/2)k(a)π(C)p(F)
where a=1, C=0.85, p=8, and F=0.000962 Wb, results in motor constants as follows:
k_{T1}: Z=989
k_{T2}: Z=1483
k_{T3}: Z=2443

Calculating turns per coil, N, according to the following equation
N=Z/[(2)(number of slots)]
yields the following results:
k_{T1}=1.27 N-m/amp, Z₁=989, N₁=27 turns per coil
k_{T2}=1.54 N-m/amp, Z₂=1483, N₂=41 turns per coil
k_{T3}=2.27 N-m/amp, Z₃=2443, N₃=68 turns per coil

Upon first examination, the above appears to be the basic information for three different motors, or three different windings. Although three separate windings could be used, only two windings required to produce the three different motor torque constants within the one motor. Note that the turns per coil, N₁=27, and N₂=41, added together result in N₃=68. If the speed range is divided into three equal parts, the motor torque constants k_{T1}+k_{T2}=k_{T3}. The plus sign, +, implies that the windings are connected as a series circuit; thus, the number of parallel paths, a, in the equation above is equal to one. Consequently, if the windings are to be combined in series to produce a number of torque ranges, n, the number of required discreet windings is w=n-1.

The winding combinations for the example motor are as follows:
winding 1, N=27 (low torque range)
winding 2, N=41 (mid-range torque)
winding 1+ winding 2, N=68 (high torque range) The method just described applies to permanent magnet motors and wound field motors.

In determining a practical benefit, consider the bicycle example cited previously. To accelerate the bicycle and rider from a stop to 15 mph in six seconds, the initial motor torque required is 48.5 N-m. For the conventional motor, the current required to produce an initial torque of 48.5 N-m is 40.4 amps based on the calculation of motor current, I=Tₘ/k_{T}. For the exemplary embodiment of the present invention set forth above, the current required to produce the initial torque of 48.5 N-m under the same conditions is 16.2 amps since the motor torque constant, k_{T} is initially 3.00 N-m/amp which is the high torque range winding. (Since the power produced by each motor is equivalent and the current requirements are different, the motor terminal voltages must be different as well.)

The example thus far has utilized the series connection of the motor windings as a method for combining the windings for a permanent magnet motor or a wound field motor having more than one torque constant. One may also design a motor in accordance with the present invention using parallel circuits as a method for effecting winding combinations. This approach is similar to the method used for the series design above with the following exceptions for calculating the number of conductors, and turns per coil.

For winding combinations in parallel the number of discreet windings required is equal to the number of torque ranges required, w=n. Therefore, using the equation for calculating the number of conductors,
Z=(3/2)k(a)π(C)p(F)]
and using the data for the example motor:
For k_{T1}=1.20 N-m/amp, a=1, Z₁=989, N₁=27 turns per coil
For k_{T2}=1.80 N-m/amp, a=2, Z₂=2967, N₂=82 turns per coil
For k_{T3}=3.00 N-m/amp, a=3, Z₃=7329, N₃=204 turns per coil
   the three distinct windings would reduce to:
k_{T1}: N₁′=27 turns per coil
k_{T2}; N₂′=N₂-N₁=82−27=55 turns per coil
k_{T3}: N₃′=N₃-N₂=204−82=122 turns per coil

Since the windings are one (1) conductor each, but the windings will be combined as parallel circuits, building the windings from the highest torque range to the lowest torque range requires that the turns per coil of the lower torque range winding be subtracted from the next higher torque range winding to determine the correct number of turns of the next conductor. The resistance of each of the parallel conductors is different due to the difference in turns per coil such that each of the conductor paths carries a different amount of current according to Ohm's Law. Since the current carried by each conductor in each torque range is different, some motor calculations, such as current density, will have to be repeated for each active conductor in each torque range. The torque produced by each of the different windings is different in magnitude but are additive since each of the torques is co-axial in a motor application. Parallel connection of the motor windings is advantageous for combining the windings for an induction alternating current motor designed in accordance with the present invention. It is important to note that both parallel and series combinations of windings are possible in any specific motor, if desired, providing for more torque ranges from the motor than would be achieved if the windings were combined in series only or parallel only within the motor. The design of a motor that would combine windings into both series and parallel circuits would follow the methods outlined above.

Returning to the series combined winding example, the speed versus torque, and current requirement for the motor having three torque ranges is shown in FIG. 5. FIG. 5 shows the desired speed versus torque curve, S/T curve, for the motor, and the current required by each of the winding combinations to produce the required torque at the desired motor speed. The current, “KE1 current”, is the same as “Current” shown in FIG. 4 representing the most efficient torque generation at higher motor speeds. However, at lower motor speeds, motor torque can be more efficiently produced by the other winding combinations.

FIG. 5 illustrates the current required by the multiple torque constant motor throughout the motor speed range. The discontinuities shown in the current trace in FIG. 5 are the switching points for changing the winding combinations.

FIG. 5 also shows that each torque range of the multiple torque constant motor has a maximum motor speed due to the back-EMF generated in the motor. Specifically, in the high torque operating range of the motor, primary winding 14 and secondary winding 15 are connected in series. In the mid-range torque operation of the motor, primary winding 14 is disengaged and only secondary winding 15 in engaged. In the low torque operating range of the motor, secondary winding 15 is disengaged and primary winding 14 is engaged.

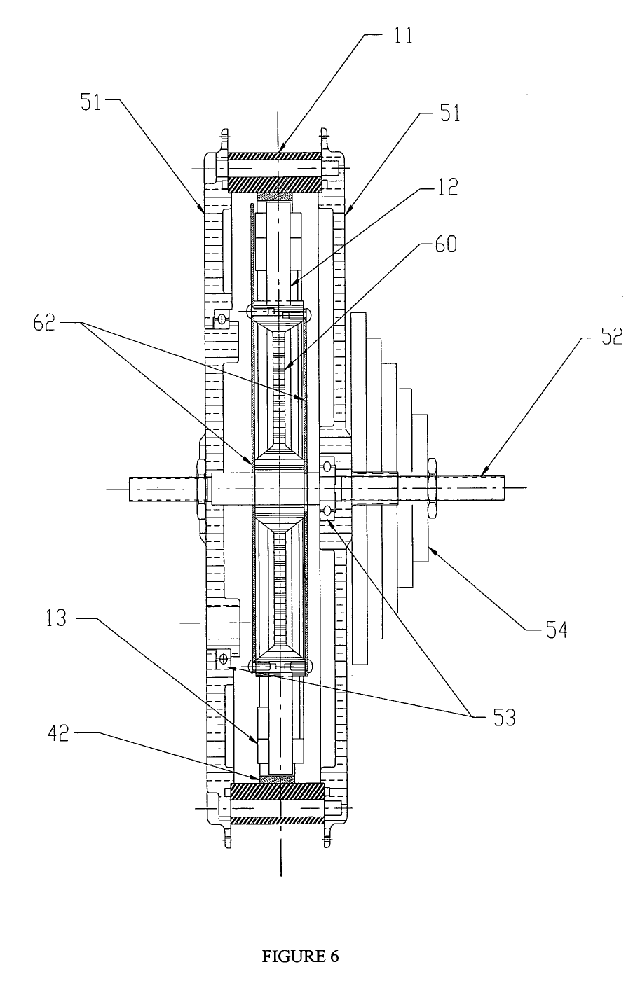

A motor designed in accordance with the present invention can be designed to have any number of torque ranges as is desirable and practical. In addition, such a motor can be used quite effectively with a gear reducer or a switchgear transmission to further enhance the efficient production of torque at the drive wheels (such as is illustrated by sprocket 54 in FIG. 6).

At the points of discontinuity, it may appear that the switching between winding combinations is abrupt. The actual switching between winding combinations occurs in only milliseconds, however, no variation in torque or speed occurs; only an increase in current occurs. The change of the torque output is very smooth depending on the quality of the controller.

As shown in FIG. 3, in an exemplary external rotor, brushless DC permanent magnet motor implementation, the stator 12 is mounted to a stator support 60. The electronics associated with the system, namely the inverter-combiner circuitry 18, the speed controller 20, and the torque controller 30, are implemented on circuit board assemblies. FIG. 2C shows a circuit board 62 mounted to the support 60 on one side of the motor; a second circuit board would be mounted to the support 60 on the other side of the motor, as shown in FIGS. 3 and 6. In this design, the rotor 11 is external to the stator.

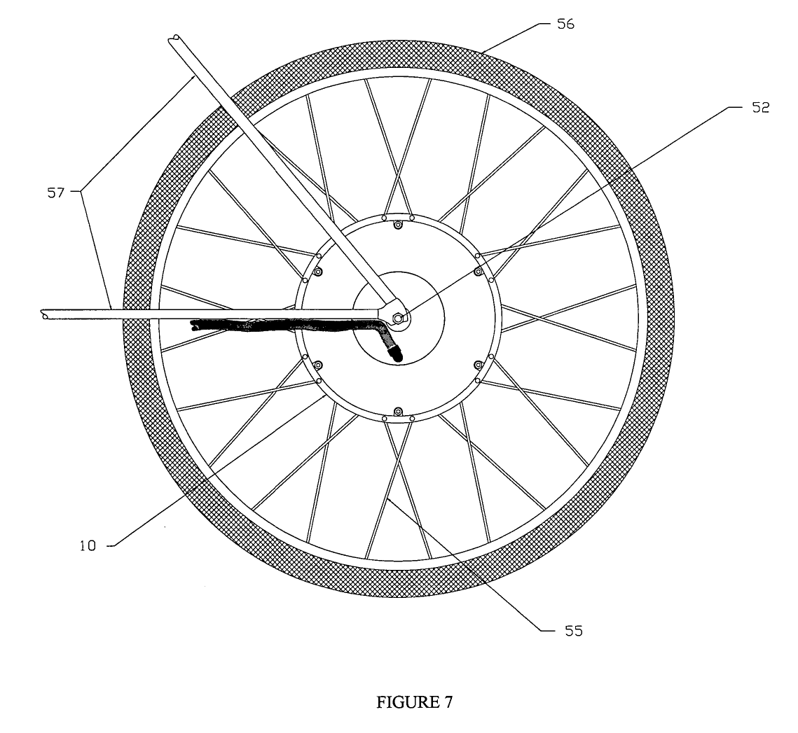

FIG. 6 and FIG. 7 show the exemplary motor of FIG. 3 mounted in an electric vehicle, namely a bicycle. FIG. 6 shows the exemplary motor as a sectional view in profile, illustrating the construction of the motor as a hub motor for an electric bicycle application. The stator 12 is securely mounted onto the stator support 60 preventing any relative motion between the stator and stator support. Likewise, the stator support 60 is securely mounted onto the axle preventing any relative motion between the stator support 60 and the axle 52. The motor is securely mounted to the frame 57 of the bicycle to prevent relative motion between the axle 52 and the bicycle frame. Thus the stator is held in a fixed orientation relative to the bicycle frame as shown in FIG. 7. The rotor is secured to two castings 51 having provision for rolling element bearings 53 relative to the axle and establishing relative location of the rotor ring to the stator such that the rotor 11 may freely rotate about the stator 12 and axle 52. The rotor 11 is assembled into the wheel of the bicycle with spokes 55, creating a wheel assembly that freely rotates about the axle 52 as shown in FIG. 7.

As the motor operates, the windings 13 of the motor are energized as combined by the inverter-combiner circuit 18 in response to the torque controller 30 and motor speed controller 20. The motor windings, when energized, develop an electromagnetic field that reacts with the magnets 16 mounted onto the rotor 11 causing the rotor 11 to rotate about the stator 12 and the axle 52 transmitting the torque of the motor to the wheel of the bicycle through the spokes 55. The wheel, rotating relative to the frame of the bicycle, causes the motion of the bicycle as demanded by the operator through the demand input signal 26 to the motor speed controller 20.

FIG. 8 is a schematic diagram of an exemplary embodiment of the torque controller 30 and inverter-combiner circuitry 18. The schematic shown represents a simple presentation of an analog logic circuit for these elements for the exemplary permanent magnet brushless direct current motor. A motor speed sensor circuit 23 and a composite speed control output signal 26 are also shown. Other circuit designs are possible using integrated circuits and digital signal processing methods. The circuit design presented is a simplified form for purposes of illustration.

In FIG. 8, the circuit element, VG1, part of motor speed sensor circuit 23 represents a small sense coil that generates an alternating current signal proportionate in amplitude and frequency to the speed of the motor as the alternating magnetic poles of the rotor pass the sense coil. The full wave bridge rectifier represented by circuit elements GR1, R1, and C1 convert the alternating current into a direct current that varies linearly with the speed of the motor from 0 Vdc to +5 Vdc, which signal was described previously as the second motor speed feedback signal 28.

The second motor speed feedback signal 28 is received by the first phase of the torque controller 30, in which the appropriate circuit branch of the controller is selected based on the magnitude of the second motor speed feedback signal 28. This function is implemented in this embodiment by resistors R2 through R9 and capacitors C2 through C5. The values of these circuit elements are selected in order to divide the applied voltage of the second motor speed feedback signal 28 to activate the appropriate logic circuits represented by circuit elements U1 through U5. The output of elements U1 through U5, in turn, activates and deactivates the circuit branches corresponding to each winding combination at the appropriate motor speed, as described below.

In FIG. 8, windings L1-L3 represent the three phases of primary winding 14 referenced above, and windings L4-L6 represent the three phases of secondary winding 15 referenced above. Circuit element U5 is an IC NAND gate connected as a NOT gate. Circuit element U6 is an IC AND gate. Elements T23-T36 are gate transistors operable to switch on or off the associated power transistors T1-T20 of the inverter-combiner circuitry 18. Elements U7 and U8 are AND line drivers, which function to split the output of the AND gate U6 into three or four output signals as required to turn “on” the proper gate transistors. Thus, the collective output of gate transistors T23-T36 comprises winding select signal 32.

The high torque range branch (for motor speeds of 0<=wₘ<9.39 rad/s in the example above) of the exemplary circuit comprises input 1A/B of U5 and input 1A/B of U6, which when “on” energizes gate transistors T21 through T26 and T28 through T31 and T35. These transistors activate the appropriate power transistors in inverter-combiner circuit 18 to allow current to pass through motor windings L1 through L6 while the other torque ranges of the logical circuits are “off”. The assumption is that the motor is at an initial velocity less than 9.39 rad/s, or starting from a stop.

As the motor speed increases in response to the speed command output signal 26 into the next predetermined interval or portion of the speed range (9.39 rad/s in the example above), the magnitude of motor speed feedback signal 28 also increases. This causes the high torque range branch to change states to “off” while the mid-torque range branch, U1, U2 and input 2 A/B of U5, and 2 A/B of U6 simultaneously switches to an “on” state. This energizes gate transistors T29 through T32 and T36 allowing current to pass through motor windings L4, L5, and L6; the high torque range and the low torque range circuits are “off”.

As the motor reaches the next predetermined speed interval (14.08 rad/s in the example above), the mid-torque range switches “off” when U2 turns “on” and, simultaneously, the low torque range branch, U3, U4, and input 3A/B of U5 and input 3 A/B of U6, switches “on” energizing gate transistors T21 through T27 and T35 allowing current to pass through motor windings L1, L2, and L3; the high-torque range and mid-torque range circuits are “off”.

If a maximum motor operating speed is desired (17.68 rad/s (16 mph) in the example above), a high-speed governor branch may be provided. When the motor reaches the predetermined maximum speed, the high-speed governor branch, represented by circuit element U4 switches “on” turning the low torque range branch “off”. Consequently, all power to the motor is switched “off” by de-energizing all gate transistors. All branches remain “off” until the motor speed is less than the predetermined maximum, causing the low torque range branch to be switched “on” again. Likewise, as the bicycle speed decreases as a result of a change initiated by the operator through speed demand input signal 22, or as a consequence of an external force acting on the bicycle, for example, ascending a hill, the sequence described above automatically switches from a lower motor torque range to a higher torque range to efficiently generate the torque required to act against the increased load applied to the bicycle.

The torque controller 30 does not drive the motor, control motor speed, or directly control motor current (although motor current will change as a result of the winding combination selected by the torque controller 30). The torque controller 30, simply stated, allows the speed command output signal 26 to reach the appropriate circuit combinations of the inverter-combiner 18. The commutation and “chopping” signals from the motor speed controller 20 (not shown for clarity), labeled as signals A-HI, A-LOW, B-HI, B-LOW, C-HI, C-LOW in FIG. 8, “pass through” the gate transistors that are in the “on” state as commanded by the torque controller 20 to operate the associated power transistors.

To illustrate the logical states commanded by the torque controller 30 and the resultant “on” and “off” states of the power transistors of the inverter-combiner circuitry 18, the inverter-combiner circuitry 18 may be conceptually divided into three parts: the primary inverter, the switching combiner, and the modifying inverter. Each inverter consists of two parts, the “chopping” section, and the “commutation” section. These sections, described by the power transistor designations are:

Primary Inverter: chopping P_{CH}: T1, T3, T5
commutation P_{COM}: T2, T4, T6

Switching Combiner: chopping S_{CH}: T7, T9, T11
commutation S_{COM}: T8, T10, T12

Modifying Inverter: chopping M_{CH}: T13, T15, T17
commutation M_{COM}: T14, T16, T18

Table 1 below shows the logical “on” and “off” states as “on”=1, and “off”=0 for each winding combination (high torque, medium torque, low torque), with the corresponding speed range from the example above:

TABLE 1

| Torque | P_{CH} | P_{COM} | S_{CH} | S_{COM} | M_{CH} | M_{COM} | Motor Speed |
|---|---|---|---|---|---|---|---|
| High | 1 | 1 | 0 | 1 | 1 | 0 | wₘ < 9.39 rad/s |
| Medium | 0 | 0 | 0 | 0 | 1 | 1 | 9.39 <= wₘ < 14.08 rad/s |
| Low | 1 | 1 | 1 | 0 | 0 | 0 | 14.08 <= wₘ < 17.68 rad/s |

The resultant logical states of the motor torque control circuitry reduce to a six bit binary code listed in the table above.

Table 1 illustrates how the current flows through the inverters and combiner circuit to operate the various windings as required. To produce the high torque, for example, the supply current flows through:
1) P_{CH} of the primary inverter through the appropriate phase of the primary winding 14, designated by L1, L2, and L3,
2) Through S_{COM}, through M_{CH}, through the appropriate phases of the secondary winding 15, designated by L4, L5, and L6,
3) Returning through M_{CH}, through S_{COM},
4) Through the appropriate phase of the primary winding, to P_{COM} to ground to complete the circuit.

The four parts of the path listed above, trace the current from the voltage source through the inverters, and the combiner circuit, the appropriate motor windings, and finally, to ground to complete the circuit. When the mid-torque range or the low torque range are active, the inactive winding is “blocked” from allowing current to flow through the windings creating an open winding condition thus eliminating any drag on the motor which would be caused by the motor back-EMF current. Another method of combining windings or creating open circuit windings would be to use contactors in place of the transistor-combiner circuit.

Although the present invention has been described and shown in considerable detail with reference to certain preferred embodiments thereof, other embodiments are possible. The foregoing description is therefore considered in all respects to be illustrative and not restrictive. Therefore, the present invention should be defined with reference to the claims and their equivalents, and the spirit and scope of the claims should not be limited to the description of the preferred embodiments contained herein.

I claim:

1. A system for efficiently delivering torque to a variable load operating over a substantially continuous predetermined range of speed, comprising
an electric motor comprising a plurality of winding combinations capable of being switched into or out of the current path through said motor, each said winding combination effecting a different predetermined torque constant for said motor;
a speed demand input signal, said electric motor comprising a speed controller responsive to said signal to vary the speed of said motor; and
a torque controller responsive to the speed of said motor to select the winding combination predetermined to most efficiently deliver the torque required by said load at said motor speed.

2. The system of claim 1, wherein said plurality of winding combinations comprises
a primary winding and
a modifying winding.

3. The system of claim 2, wherein said plurality of winding combinations further comprises the primary winding in series with the modifying winding.

4. The system of claim 3, wherein the predetermined range of speed is divided into a high speed interval, a medium speed interval, and a low speed interval, each interval comprising a one-third portion of the predetermined speed range and having one of said plurality of winding combinations associated with it, and wherein the torque constant of the winding combination for the low speed interval is the sum of the torque constants of the winding combinations for the medium speed interval and the winding combination of the high speed interval.

5. The system of claim 2, wherein said plurality of winding combinations further comprises the primary winding in parallel with the modifying winding.

6. The system of claim 5, wherein said plurality of winding combinations further comprises the primary winding in series with the modifying winding.

7. The system of claim 1, wherein said plurality of winding combinations comprises
a primary winding;
a first modifying winding; and
a second modifying winding.

8. The system of claim 1, wherein said motor is a permanent magnet direct current motor.

9. The system of claim 8, wherein said motor is brushless.

10. The system of claim 8, wherein said motor is electrically commutated.

11. The system of claim 1, wherein said motor is an alternating current induction motor.

12. The system of claim 1, wherein said speed controller is selected from the group consisting of:
a variable resistance speed controller;
a variable amplitude speed controller;
a variable frequency speed controller; and
a pulse width modulation speed controller.

13. The system of claim 1, further comprising a mechanical transmission coupled to the rotor of said electric motor.

14. The system of claim 1, wherein said torque controller is analog.

15. The system of claim 1, wherein said torque controller is digital.

16. The system of claim 1, wherein said speed demand input signal comprises a signal selected from the group consisting of demanded speed, brake command, regeneration braking, coast, and reverse direction.

17. A vehicle comprising a wheel operable to rotate about an axle, said vehicle powered at least in part by an electrical power source comprising
an electric motor comprising a rotor, a stator, and a plurality of winding combinations capable of being switched into or out of the current path through said motor, each said winding combination effecting a different predetermined torque constant for said motor, the rotor of said electric motor coupled to said wheel;
a speed demand input signal, said electric motor comprising a speed controller responsive to said signal to vary the speed of said motor; and
a torque controller responsive to the speed of said motor to select the winding combination predetermined to most efficiently deliver the torque required by said load at said motor speed.

18. The vehicle of claim 17, wherein said speed demand input signal comprises a signal selected from the group consisting of demanded speed, brake command, regeneration braking, coast, and reverse direction.

19. The vehicle of claim 17, further comprising a mechanical transmission coupled to said rotor and said wheel.

20. An electric motor system for efficiently delivering torque to a variable load operating over a substantially continuous predetermined range of speed, comprising:
an electric motor comprising a plurality of winding combinations capable of being switched into or out of the current path through said motor, each said winding combination effecting a different predetermined torque constant for said motor and predetermined to operate over a portion of said predetermined speed range;
a speed demand input signal, said electric motor varying its motor speed in response to said signal; and
a torque controller responsive to said motor speed to select the winding combination predetermined to correspond to said motor speed,
such that as motor speed varies in response to said demand input signal the torque controller automatically selects the winding combination predetermined to operate at the actual motor operating speed.

21. The system of claim 20, wherein the number of turns in each of said winding combinations is optimized for reduced current flow over its portion of the predetermined speed range.

22. The system of claim 20, wherein said plurality of winding combinations comprises
a primary winding and
a modifying winding.

23. The system of claim 22, wherein said plurality of winding combinations further comprises the primary winding in series with the modifying winding.

24. The system of claim 23, wherein the predetermined range of speed is divided into a high speed interval, a medium speed interval, and a low speed interval, each interval comprising a one-third portion of the total speed range and having one of said plurality of winding combinations associated with it, and wherein the torque constant of the winding combination for the low speed interval is the sum of the torque constants of the winding combinations for the medium speed interval and the winding combination of the high speed interval.

25. The system of claim 22, wherein said plurality of winding combinations further comprises the primary winding in parallel with the modifying winding.

26. The system of claim 25, wherein said plurality of winding combinations further comprises the primary winding in series with the modifying winding.

27. A method of designing a motor with multiple efficient operating points over a predetermined range of speed to drive a variable load, comprising
identifying the speed range and torque requirements of the load;
dividing the speed range into a plurality of intervals;
selecting a speed within each of said intervals;
computing a motor constant at said selected speed for each of said intervals;
computing the number of conductors and turns per coil necessary for a winding combination to provide the computed motor constant for each of said intervals;
providing a logic circuit responsive to motor speed to select the winding combination corresponding to the speed interval into which said motor speed falls.

28. The method of claim 27, wherein said selected speed for each of said intervals is
the maximum speed of each of said intervals.
